(19) United States
(12) Patent Application Publication
(10) Pub. No.: US 2006/0261051 A1
(43) Pub. Date: Nov. 23, 2006

(54) Synthetic pulse repetition rate processing for dual-headed laser micromachining systems

(76) Inventors: Mark Unrath, Portland, OR (US); Brian Johansen, Hillsboro, OR (US); Ho Wai Lo, Portland, OR (US)

Correspondence Address: STOEL RIVES LLP, 900 SW FIFTH AVENUE, SUITE 2600, PORTLAND, OR, 97204-1268, US

(21) Appl. No.: 11/134,242

(22) Filed: May 19, 2005

(51) Int. Cl. B23K 26/067

(52) U.S. Cl. 219/121.76

(57) ABSTRACT

A method and system for increasing throughput of laser micromachining systems use more than one laser. Two or more pulsed laser beams are combined and then separated into multiple laser beams that enable the system to work simultaneously at multiple locations on the workpiece with pulse rates greater than those achievable with independently operating lasers while maintaining pulse energy equal to or greater than the pulse energy of each of the original independent laser beams. Most laser micromachining applications required multiple sequential pulses to process a workpiece. Increasing the pulse rate while maintaining pulse energy effects more rapid material removal and thereby increases throughput for a laser micromachining system.

### TECHNICAL FIELD

The present invention relates to laser processing a workpiece and, in particular, to combining the outputs of two or more lasers to achieve at a given power level a pulse repetition frequency that is greater than the repetition frequency of either laser operating independently at the given power level.

### BACKGROUND OF THE INVENTION

Laser processing can be conducted on numerous different workpieces using various lasers effecting a variety of processes. The specific types of laser processing of interest with regard to the present invention are laser processing of a single or multilayer workpiece to effect hole and/or blind via formation and laser processing of a semiconductor wafer to effect wafer dicing or drilling. The laser processing methods described herein could also be applied to any type of laser micromachining, including but not limited to removal of semiconductor links (fuses) and thermal annealing or trimming passive thick or thin film components.

Regarding laser processing of vias and/or holes in a multilayer workpiece, U.S. Pat. Nos. 5,593,606 and 5,841,099 of Owen et al. describe methods of operating an ultraviolet (UV) laser system to generate laser output pulses characterized by pulse parameters set to form in a multilayer device through-hole or blind vias in two or more layers of different material types. The laser system includes a nonexcimer laser that emits, at pulse repetition rates of greater than 200 Hz, laser output pulses having temporal pulse widths of less than 100 ns, spot areas having diameters of less than 100 μm, and average intensities or irradiance of greater than 100 mW over the spot area. The preferred nonexcimer UV laser identified is a diode-pumped, solid-state (DPSS) laser.

Published U.S. Patent Application No. US/2002/0185474 of Dunsky et al. describes a method of operating a pulsed CO₂ laser system to generate laser output pulses that form blind vias in a dielectric layer of a multilayer device. The laser system emits, at pulse repetition rates of greater than 200 Hz, laser output pulses having temporal pulse widths of less than 200 ns and spot areas having diameters of between 50 μm and 300 μm.

Laser ablation of a target material, particularly when a UV DPSS laser is used, relies upon directing to the target material a laser output having a fluence or energy density that is greater than the ablation threshold of the target material. A UV laser emits a laser output that can be focused to have a spot size of between about 10 μm and about 30 μm at the 1/e² diameter. In certain instances, this spot size is smaller than the desired via diameter, such as when the desired via diameter is between about 50 μm and 300 μm. The diameter of the spot size can be enlarged to have the same diameter as the desired diameter of the via, but such enlargement would reduce the laser output energy density to the extent that it is less than the target material ablation threshold and cannot effect target material removal. Consequently, the 10 μm to 30 μm focused spot size is used and the focused laser output is typically moved in a spiral, concentric circular, or “trepan” pattern to form a via having the desired diameter. Spiraling, trepanning, and concentric circle processing are types of so-called non-punching via formation processes. For via diameters of about 70 μm or smaller, direct punching delivers a higher via formation throughput.

In contrast, the output of a pulsed CO₂ laser is typically larger than 50 μm and is capable of maintaining an energy density sufficient to effect formation of vias having diameters of 50 μm or larger on conventional target materials. Consequently, a punching process is typically employed when a CO₂ laser is used to effect via formation. However, a via having a spot area diameter of less than 50 μm cannot be formed using a CO₂ laser.

The high degree of reflectivity of copper at the CO₂ wavelength makes very difficult the formation of a through-hole via using a CO₂ laser in a copper sheet having a thickness greater than about 5 microns. Thus CO₂ lasers can typically be used to form through-hole vias only in copper sheets that have thicknesses of between about 3 microns and about 5 microns or that have been surface treated to enhance the absorption of the CO₂ laser energy.

The most common materials used in making multilayer structures for printed circuit board (PCB) and electronic packaging devices in which vias are formed typically include metals (e.g., copper) and dielectric materials (e.g., polymer polyimide, resin, or FR-4). Laser energy at UV wavelengths exhibits good coupling efficiency with metals and dielectric materials, so the UV laser can readily effect via formation on both copper sheets and dielectric materials. Also, UV laser processing of polymer materials is widely considered to be a combined photo-chemical and photo-thermal process, in which the UV laser output partly ablates the polymer material by disassociating its molecular bonds through a photon-excited chemical reaction, thereby producing superior process quality as compared to the photo-thermal process that occurs when the dielectric materials are exposed to longer laser wavelengths. For these reasons, solid-state UV lasers are preferred laser sources for processing these materials.

CO₂ laser processing of dielectric and metal materials and UV laser processing of metals are primarily photo-thermal processes, in which the dielectric material or metal material absorbs the laser energy, causing the material to increase in temperature, soften or become molten, and eventually ablate, vaporize, or blow away. Ablation rate and via formation throughput are, for a given type of material, a function of laser energy density (laser energy (J) divided by spot size (cm²)), power density (laser energy density divided by pulse width (seconds)), pulse width, laser wavelength, and pulse repetition rate.

Thus, laser processing throughput, such as, for example, via formation on PCB or other electronic packaging devices or hole drilling on metals or other materials, is limited by the laser power density available and pulse repetition rate, as well as the speed at which the beam positioner can move the laser output in a spiral, concentric circle, or trepan pattern and between via positions. An example of a UV DPSS laser is a Model LWE Q302 (355 nm) sold by Lightwave Electronics, Mountain View, Calif. This laser is used in a Model 5330 laser system or other systems in its series manufactured by Electro-Scientific Industries, Inc., Portland, Oreg., the assignee of the present patent application. The laser is capable of delivering 8 W of UV power at a pulse repetition rate of 30 kHz. The typical via formation throughput of this laser and system is about 600 vias each second on bare resin. An example of a pulsed CO₂ laser is a Model Q3000 (9.3 μm) sold by Coherent-DEOS, Bloomfield, Conn. This laser is used in a Model 5385 laser system or other systems in its series manufactured by Electro-Scientific Industries, Inc. The laser is capable of delivering 18 W of laser power at a pulse repetition rate of 60 kHz. The typical via formation throughput of this laser and system is about 1000 vias each second on bare resin and 250-300 vias each second on FR-4.

Increased via formation throughput can be accomplished by increasing the pulse repetition rate at a pulse energy sufficient to cause ablation as described above. However, for the UV DPSS laser and the pulsed CO₂ laser, as pulse repetition rates increase, pulse energy decreases in a non-linear fashion, i.e., twice the pulse repetition rate results in less than one-half the pulse energy for each pulse. Thus for a given laser, there will be a maximum pulse repetition rate and hence maximum rate of via formation governed by the minimum pulse energy needed to cause ablation.

Regarding dicing a semiconductor wafer, there are two common methods of effecting the dicing: mechanical sawing and laser dicing. Mechanical sawing typically entails using a diamond saw to dice wafers having a thickness of greater than about 150 microns to form streets having widths of greater than about 100 microns. Mechanically sawing wafers having a thickness that is less than about 100 microns results in cracking of the wafer.

Laser dicing typically entails dicing the semiconductor wafer using a pulsed IR, green, or UV laser. Laser dicing offers various advantages over mechanically sawing a semiconductor wafer, such as the ability to reduce the width of the street to about 50 microns when using a UV laser, the ability to dice a wafer along a curved trajectory, and the ability to effectively dice silicon wafers thinner than those that can be diced using mechanical sawing. For example, a silicon wafer having a thickness of about 75 microns may be diced with a DPSS UV laser operated at a power of about 8 W and a repetition rate of about 30 kHz at a dicing speed of 120 mm/sec to form a kerf having a width of about 35 microns. However, one disadvantage of laser dicing semiconductor wafers is the formation of debris and slag, both of which could adhere to the wafer and are difficult to remove. Another disadvantage of laser dicing semiconductor wafers is that the workpiece throughout rate is limited by the power capabilities of the laser.

What is needed, therefore, is a method of and laser system for effecting high-speed laser processing of a workpiece at a high rate of throughput to effect the formation of vias and/or holes using UV, green, IR, and CO₂ lasers and to efficiently and accurately dice semiconductor wafers using UV, green, and IR lasers.

### SUMMARY OF THE INVENTION

An object of the present invention is, therefore, to provide a method of and a laser system for improving the speed and/or efficiency of (1) laser processing vias and/or holes in single and multilayer workpieces and (2) dicing semiconductor wafers such that the rates of material removal and workpiece throughput are increased and process quality is improved.

The method of the present invention effects rapid removal of material from a workpiece by maximizing the pulse repetition rate at a given power level in a dual laser system. The method entails triggering two lasers so that the individual pulses appear at different times at the outputs of the lasers. These two beams are then combined into a single beam in which the pulses of the two beams are interleaved. The single beam has a pulse repetition frequency (PRF) that is equal to the combined pulse rate of each beam, and each pulse in the combined beam has the same pulse characteristics as it had before combination. The combined beam may be subsequently divided into two beams that have the same PRF. In the divided beams, some of the pulse characteristics, such as pulse duration and overall pulse shape, will remain substantially similar to those of the undivided beam. Some of the pulse characteristics, such as pulse peak power and pulse energy, will, however, be divided between the two beams such that the linear sum of the pulse characteristics will be approximately equal to those of the undivided beam.

A preferred embodiment of the method entails synchronizing two lasers to achieve alternate pulsing at the desired PRF. The two pulsed laser beams produced at the laser outputs are then collimated and directed for incidence on a beam combiner, which combines them into a single beam. The combined beam may be left in its inherent Gaussian profile or optionally shaped and/or imaged to create a desired non-Gaussian profile. The combined beam is then divided into two beams, which may be directed for incidence on different locations of the workpiece to perform micromachining. Because of the non-linear nature of the relationship between PRF and power, the combining and separating of the two beams result in greater power density at two locations on the workpiece than that which would be achievable if each laser were separately pulsed and directed to the workpiece at each of two locations at the equivalent PRF. The consequence of achieving greater power density in this manner is an increase in the throughput of the micromachining system.

The advantages afforded by this invention are not limited to two lasers. Using similar techniques, three or more lasers could be combined and divided into three or more beams; however, even numbers of lasers are easier to combine and divide into similar output beams.

Additional objects and advantages of this invention will be apparent from the following detailed description of preferred embodiments thereof, which proceeds with reference to the accompanying drawings.

### BRIEF DESCRIPTION OF THE DRAWINGS

FIG. 1 is a fragmentary view of an exemplary multilayer workpiece of the type to be processed by a laser beam formed in accordance with the method of the present invention.

FIG. 2 is a simplified schematic diagram of a preferred system that combines two laser beams and later divides them in accordance with the method of the present invention in cooperation with optional beam shaping and imaging optics. FIG. 2 also shows in phantom lines optical components that further divide the combined laser beams into optional third and fourth laser beams.

FIG. 3 is a graph showing the relationship between pulse energy and PRF for an exemplary prior art laser.

FIG. 4 is a graph showing the relationship between pulse energy and PRF for a two-laser system beam output formed in accordance with the present invention.

FIG. 5A is a graph showing the pulse train PRF and peak energy produced by a prior art dual laser system in which each laser operates independently.

FIG. 5B is a graph showing the pulse train PRF and peak energy of a combined laser beam produced in accordance with the present invention.

FIG. 5C is a graph showing the pulse train PRF and peak energy for a separated laser beam produced in accordance with the present invention.

### DETAILED DESCRIPTION OF PREFERRED EMBODIMENTS

In a first implementation of a preferred embodiment of this invention, laser pulses generated by the invention disclosed herein form vias in single layer or multilayer workpieces by aiming a laser at least two particular areas of the workpiece with sufficient energy to cause ablation. It is assumed that a single pulse is insufficient to remove all of the desired material from a particular location on the workpiece. Multiple pulses are, therefore, directed to the workpiece to effect removal of the desired material at each specified location. The processing time and hence the system throughput is dependent upon the number of pulses delivered to the workpiece for each unit time at energies above the ablation threshold of the workpiece.

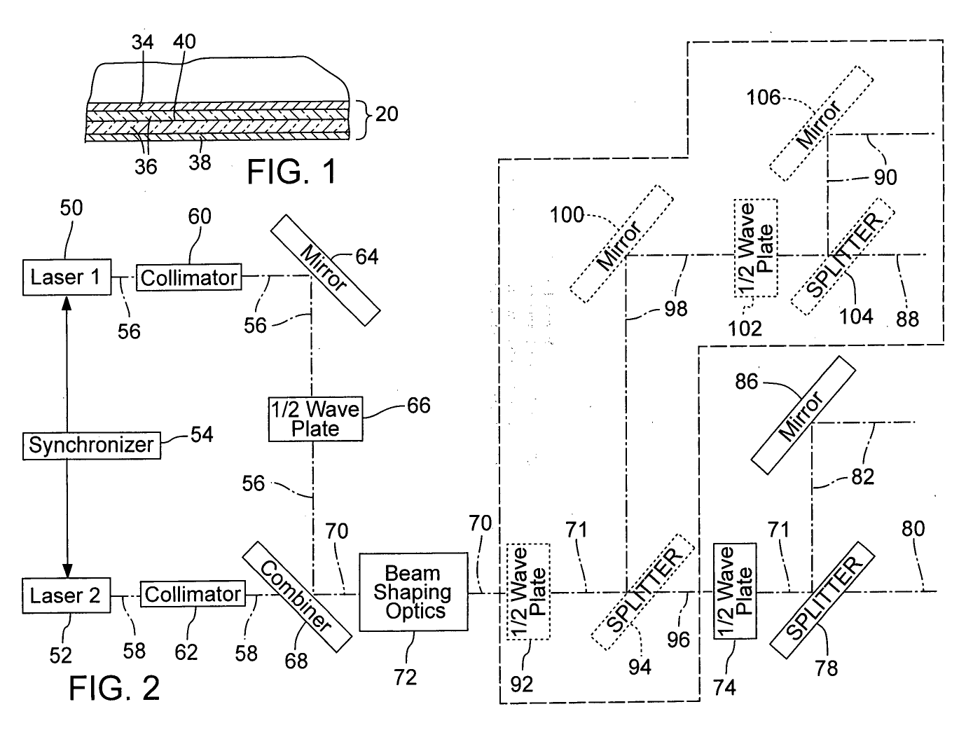

Preferred single layer workpieces include thin copper sheets, polyimide sheets for use in electrical applications, and other metal pieces, such as aluminum, steel, and thermoplastics, for general industry and medical applications. Preferred multilayer workpieces include a multi-chip module (MCM), circuit board, or semiconductor microcircuit package. FIG. 1 shows an exemplary multilayer workpiece 20 of an arbitrary type that includes layers 34, 36, 38, and 40. Layers 34 and 38 are preferably metal layers that each include a metal, such as, but not limited to, aluminum, copper, gold, molybdenum, nickel, palladium, platinum, silver, titanium, tungsten, a metal nitride, or a combination thereof. Metal layers 34 and 38 preferably have thicknesses that are between about 9 μm and about 36 μm, but they may be thinner than 9 μm or as thick as 72 μm.

Each layer 36 preferably includes a standard organic dielectric material such as benzocyclobutane (BCB), bismaleimide triazine (BT), cardboard, a cyanate ester, an epoxy, a phenolic, a polyimide, polytetrafluorethylene (PTFE), a polymer alloy, or a combination thereof. Each organic dielectric layer 36 is typically thicker than metal layers 34 and 38. The preferred thickness of organic dielectric layer 36 is between about 20 μm and about 400 μm, but organic dielectric layer 36 may be placed in a stack having a thickness as great as 1.6 mm.

Organic dielectric layer 36 may include a thin reinforcement component layer 40. Reinforcement component layer 40 may include fiber matte or dispersed particles of, for example, aramid fibers, ceramics, or glass that have been woven or dispersed into organic dielectric layer 36. Reinforcement component layer 40 is typically much thinner than organic dielectric layer 36 and may have a thickness that is between about 1 μm and about 10 μm. Skilled persons will appreciate that reinforcement material may also be introduced as a powder into organic dielectric layer 36. Reinforcement component layer 40 including this powdery reinforcement material may be noncontiguous and nonuniform.

Skilled persons will appreciate that layers 34, 36, 38, and 40 may be internally noncontiguous, nonuniform, and nonlevel. Stacks having several layers of metal, organic dielectric, and reinforcement component materials may have a total thickness that is greater than 2 mm. Although the arbitrary workpiece 20 shown as an example in FIG. 1 has five layers, the present invention can be practiced on a workpiece having any desired number of layers, including a single layer substrate.

FIG. 2 is a simplified schematic diagram of a preferred embodiment of the present invention composed of two processing lasers 50 and 52 driven by a synchronizer source 54. Source 54 could synchronize lasers 50 and 52 by any one of a number of methods including synchronizing the trigger signals sent to illumination sources that pump energy into the lasers or possibly synchronizing Q-switches positioned inside the lasers 50 and 52 to enable them to pulse in an alternating fashion. The lasers 50 and 52 provide at their outputs respective processing beams 56 and 58, each comprised of a laser pulse train. The lasers 50 and 52 are arranged so that the intrinsic linear polarization planes of their respective output processing beams 56 and 58 are substantially parallel. Laser beams 56 and 58 pass through respective collimators 60 and 62, each reducing the diameter of its incident laser beam while maintaining its focus at infinity.

Processing lasers 50 and 52 may be a UV laser, an IR laser, a green laser, or a CO₂ laser. A preferred processing laser output has a pulse energy that is between about 0.01 μJ and about 1.0 J. A preferred UV processing laser is a Q-switched UV DPSS laser including a solid-state lasant such as Nd:YAG, Nd:YLF, Nd:YAP, or Nd:YVO4, or a YAG crystal doped with ytterbium, holmium, or erbium. The UV laser preferably provides harmonically generated UV laser output at a wavelength such as 355 nm (frequency tripled Nd:YAG), 266 nm (frequency quadrupled Nd:YAG), or 213 nm (frequency quintupled Nd:YAG).

A preferred CO₂ processing laser is a pulsed CO₂ laser operating at a wavelength of between about 9 μm and about 11 μm. An exemplary commercially available pulsed CO₂ laser is the Model Q3000 Q-switched laser (9.3 μm) manufactured by Coherent-DEOS of Bloomfield, Conn. Because CO₂ lasers are unable to effectively drill vias through metal layers 34 and 38, multilayer workpieces 20 drilled with CO₂ processing lasers either lack metal layers 34 and 38 or are prepared such that a target location has been pre-drilled with a UV laser or pre-etched using another process such as, for example, chemical etching, to expose dielectric layer 36.

Skilled persons will appreciate that other solid-state lasants or CO₂ lasers operating at different wavelengths may be used in the laser system of the present invention. Various types of laser cavity arrangement, harmonic generation of the solid state laser, Q-switch operation for both the solid-state laser and the CO₂ laser, pumping schemes, and pulse generation methods for the CO₂ laser are well known to those skilled in the art.

Laser 50 emits a processing beam 56 that reflects off a mirror/combiner 64, which in the case of two lasers is implemented as a mirror, and subsequently encounters a first ½ wave plate 66. The first ½ wave plate 66 is set to rotate by 90° the polarization plane of the incident laser beam 56. The optical paths of laser beams 56 and 58 are arranged to meet at a beam combiner 68 that is constructed to transmit substantially all of laser beam 58 polarized at a first angle and reflect substantially all of laser beam 56 polarized at a second angle that is rotated 90° relative to the first angle. The optical components are arranged so that the transmitted beam 58 and the reflected beam 56 combine to form a combined coaxial beam 70 having approximately one-half of its energy polarized at a first angle and the rest of its energy polarized at a second angle rotated 90° relative to the first angle. The combined beam 70 propagating from beam combiner 68 passes through optional beam shaping optics 72, which transform the essentially Gaussian beam profile into a more desirable beam profile. An example of a desirable beam profile is the “top hat” profile, which provides essentially even illumination. The optional beam shaping optics 72 also serves as imaging optics, which enables the beam to achieve the appropriate properties such as spot size and shape when it is projected onto the workpiece. Those skilled in the art will also recognize that similar methods could be used to combine more than two lasers to create combined beam 70 with correspondingly more power.

The combined beam 70 is then directed for incidence on a second ½ wave plate 74, which as a result of being rotated by 22.5° rotates the polarization planes of the combined beam 70 by 45 degrees providing a beam with substantially equal p (vertical) and s (horizontal) polarization components. The combined and rotated beam 71 is directed onto a Brewster polarizer beam splitter 78 with its polarization axes set 45° relative to either of the polarization planes of combined and rotated beam 71. In the absence of the second ½ wave plate 74, the beam splitter 78 would transmit substantially all of the portion of the combined and rotated beam 71 that was polarized parallel to the beam splitter polarization axis and reflect substantially all of the portion of the combined and rotated beam 71 that was polarized perpendicular to the beam splitter polarization axis. This would essentially separate the combined and rotated beam 71 into its constituent parts, recreating laser beams 56 and 58. However, since the polarization of combined and rotated beam 71 has been rotated 45°, each of the orthogonally polarized components of the combined and rotated beam 71 is partly transmitted and partly reflected by the beam splitter 78. This has the effect of mixing the two polarized components of the combined and rotated beam 71, transmitting about one-half of the power and reflecting about one-half of the power in separated laser beams 80 and 82. Each of these separated beams 80 and 82 is comprised of pulses from both laser beams 56 and 58 and hence has a pulse rate equal to the sum of the pulse rates of the two beams. The ratio of power in the two separated beams 80 and 82 can be adjusted by varying the angle of the ½ wave plate 74 from the nominal angle of 22.5°.

The combined and rotated beam 71 can optionally be divided into four laser beams 80, 82, 88, and 90, each of which equal to about one-fourth of the combined power of lasers 50 and 52 and having a pulse rate equal to the sum of the pulse rates of beams 56 and 58 emitted by lasers 50 and 52, respectively. This division is accomplished by the components shown in a dashed line enclosure and represented by phantom lines in FIG. 2. The combined and rotated beam 71, which is the optional embodiment initially propagates from a ½ wave plate 92, is divided into two approximately equal beams by optional splitter 94 to create optional beams 96 and 98. Each of beams 96 and 98 can be directed by well-known techniques to desired locations on the workpiece by optional mirror 100, optional ½ wave plate 102, optional splitter 104, and optional mirror 106 to create a total of four output beams 80, 82, 88, and 90. The ratio of power available to each beam can be set by adjusting ½ wave plates 74, 92, and 102 as described above. Those skilled in the art will recognize that this method can be extended to create additional pairs of laser beams as desired.

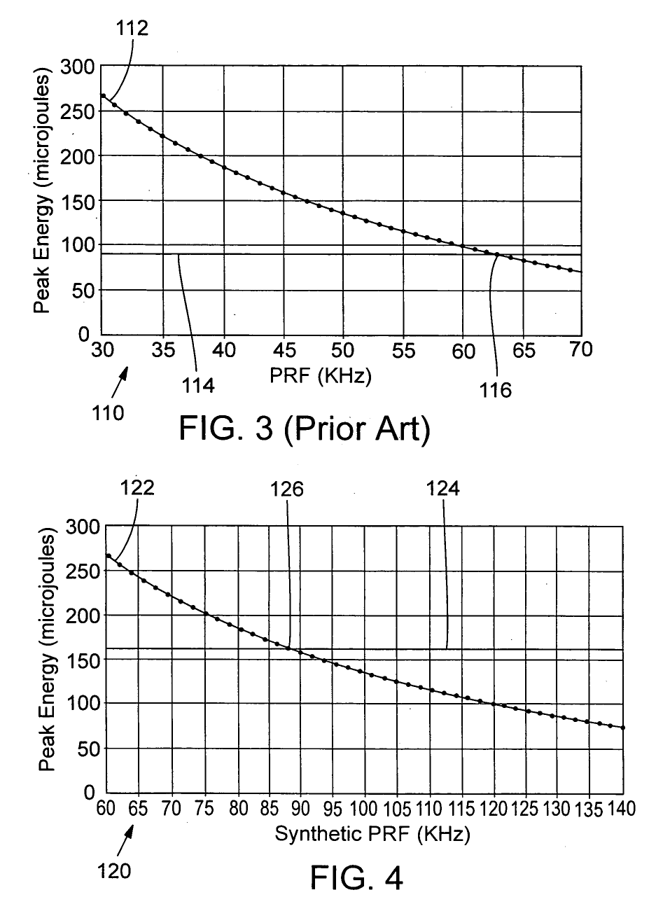

Graph 110 in FIG. 3 illustrates the non-linear relationship between PRF in kHz and pulse energy in μJ for a single laser. Curved line 112 represents the peak pulse energy available as a function of PRF for a given laser. Those skilled in the art will recognize that this relationship is typical for a wide range of laser types used for micromachining applications. Straight line 114 represents the minimum peak pulse energy, about 80 μJ, required for ablation of a particular workpiece. Lines 112 and 114 intersect at a point 116 that represents the maximum PRF usable to ablate the workpiece selected, which in this case is about 62 kHz. If a system were constructed with two lasers operating independently, the maximum throughput of the system would be limited to two spots, each being ablated at 62 kHz.

Graph 120 in FIG. 4 illustrates the performance of a dual laser system constructed in accordance with the principles described herein. Two lasers with PRF/pulse energy characteristics identical to those shown in FIG. 3 are combined as shown in FIG. 2. Curved line 122 in graph 120 shows the PRF/pulse energy relationship of the combined beam 70 comprised of alternating pulses from lasers 50 and 52. Straight line 124 in graph 120 shows the minimum peak pulse energy required to ablate the selected workpiece. Since combined beam 70 is to be divided substantially equally between two beams, the peak pulse energy required is about twice the peak pulse energy shown by straight line 104 in FIG. 3, or about 160 μJ. Lines 122 and 124 intersect at a point 126 that represents the maximum combined PRF, about 87 kHz, usable to ablate the selected workpiece. Because of the non-linear relationship between PRF and pulse energy, this PRF is greater than the 62 kHz PRF shown in FIG. 3 to ablate the same material. Thus, a two laser system implemented in accordance with the techniques disclosed herein would have a maximum system throughput equal to two spots being ablated at a PRF of 87 kHz. Since the maximum ablation rate and hence the system throughput is a function of the PRF, a two laser system constructed in accordance with the principles disclosed herein would have a throughput of up to 140% of that of a system constructed with each laser operating independently.

In a second implementation of a preferred embodiment; the laser pulses generated by the invention disclosed herein are used to effect singulation or dicing of a wafer or substrate into multiple independent parts. It is common in electronics manufacturing to construct multiple copies of a given circuit or circuit element on a single substrate. Preferred workpieces for semiconductor dicing include silicon wafers, other silicon-based materials including silicon carbide and silicon nitride, and compounds in the III-V and II-VI groups, such as gallium arsenide upon which integrated circuits are constructed using photolithography techniques. A second example is thick film circuitry, in which circuit elements or electronic devices are screen printed on a substrate typically made of a sintered ceramic material. A third example is thin film circuitry, in which conductors and passive circuit elements are applied to a substrate made of, for instance, a semiconductor material, ceramic or other materials, by sputtering or evaporation. A fourth example would be display technology, in which the plastic films used to manufacture LCD or plasma displays can be singulated using this technology. What these applications all have in common is the desire to efficiently divide a substrate containing multiple circuits, circuit elements, or simply regions of the substrate into separate parts.

The advantages of applying the invention disclosed herein to singulation are similar to the advantages described above for via drilling. Applying two or more lasers to the process can increase the throughput of a system, since multiple parallel linear cuts are typically required to singulate most substrates. Using the invention described herein will increase the throughput of the system, since the rate of singulation, like via drilling, is a function of the number of pulses at energies greater than the ablation threshold delivered for each unit time.

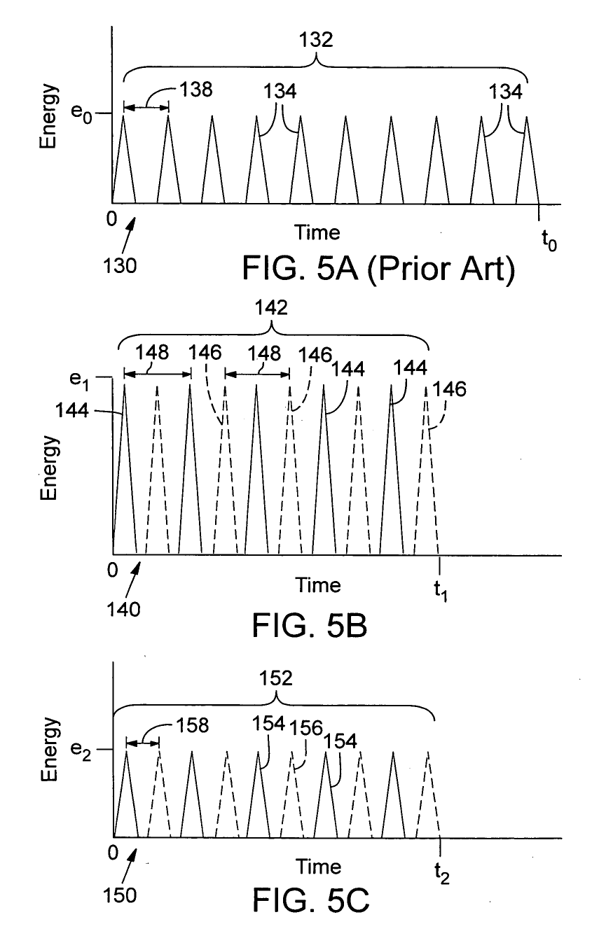

FIGS. 5A, 5B, and 5C illustrate this process by comparing the number of pulses delivered for each unit time by a dual laser system constructed with independent lasers and a dual laser system constructed according to the invention disclosed herein.

Graph 130 in FIG. 5A shows the relationship between pulse energy and PRF for one of two similar exemplary lasers in a prior art system that uses two independent lasers to process two locations on a workpiece at the same time. Graph 130 shows a pulse train 132, each pulse 134 having a pulse energy e₀, requiring time t₀ to complete processing at a particular location on a workpiece. Interval 138 shows the time between adjacent pulses 134, which is the reciprocal of PRF. Since it represents a two laser system, this system can process two locations on a workpiece in time to.

Graph 140 in FIG. 5B shows the combined beam 70 comprised of a pulse train 142. The pulse train 142 is comprised of solid line pulses 144 from laser 50 and dashed line pulses 146 from laser 52 after having been combined by beam combiner 68. The peak energy e₁ of each pulse 144, 146 is equal to more than twice the peak energy e₀ of each pulse 134 of a beam delivered by a similar laser at the PRF illustrated in FIG. 5A, while the intervals 148 between adjacent pulses 144 from laser 50 and between adjacent pulses 146 from laser 52 are each less than twice the interval 138. This is a consequence of the non-linear relationship between pulse energy and PRF illustrated in FIGS. 3 and 4.

Graph 150 in FIG. 5C shows the result of dividing pulse train 142 with beam splitter 78 to form two pulse trains, one of which is shown as pulse train 152, comprised of solid line pulses 154 from laser 50 and dashed line pulses 156 from laser 52. The peak energy e₂ of the divided beam 152 is equal to the peak energy e₀ of a single laser as shown in FIG. 5A, but the inter-pulse interval 158 is less than the inter-pulse interval 138. The PRF synthesized from two laser beams is, therefore, greater than the PRF of either of two lasers working independently. Thus the required number of pulses is delivered to the workpiece in time t₂, which less than time t₀. Since two pulse trains 152 are delivered to the workpiece by the divided laser beams 56 and 58, the invention described herein can process two locations in less time than that which would be required if the lasers worked independently.

Skilled persons will appreciate that for different single or multilayer workpieces composed of different materials, varying laser parameters, such as pulse repetition rate, energy per pulse, and beam spot size, can be programmed during different processing stages to effect optimal laser micromachining throughput and quality. See, e.g., U.S. Pat. No. 5,841,099 of Owen et al. and U.S. Pat. No. 6,407,363 of Dunsky et al., both of which are assigned to the assignee of the present patent application. Those skilled in the art will also appreciate that the operational parameters of the heating source, such as its power, energy distribution profile, and spot size, can be kept constant or changed during various stages of laser processing.

It will be obvious to those having skill in the art that many changes may be made to the details of the above-described embodiments of this invention without departing from the underlying principles thereof. The scope of the present invention should, therefore, be determined only by the following claims.

1. A method of producing first and second processing laser beams and using them to concurrently and rapidly process target material at respective first and second target material locations, comprising:
providing a first laser that emits at a pulse repetition frequency a series of output pulses characterized by peak pulse energies that decrease with increasing pulse repetition frequency;
providing a second laser that emits at a pulse repetition frequency a series of output pulses characterized by peak pulse energies that decrease with increasing pulse repetition frequency;
forming a combined laser output in which the output pulses of the first and second lasers are interleaved, the combined laser output operating at a processing pulse repetition frequency established by synthesis of the pulse repetition frequencies of the series of output pulses of the first and second lasers;
splitting the combined laser output into first and second processing laser beams that include series of combined laser processing output pulses characterized by peak processing pulse energies; and
directing the first and second processing laser beams for incidence on respective first and second target material locations to concurrently remove target material from them, the peak processing pulse energies of the combined laser processing output pulses being greater than the peak pulse energies achievable by the first and second lasers operating independently at the processing pulse repetition frequency, thereby enabling selection of a peak processing pulse energy that is effective for target material processing at a processing rate greater than that which is realizable from independent operation of the first and second lasers.

2. The method of claim 1, in which the pulse repetition frequencies of the series of output pulses of the first and second lasers are substantially the same.

3. The method of claim 2, in which the output pulses of each of the first and second processing laser beams are formed in a series of alternating output pulses of the first and second lasers.

4. The method of claim 1, in which the processing of target material includes removal of target material from the first and second target material locations.

5. The method of claim 1, in which the pulse repetition frequencies of the series of output pulses of the first and second lasers are substantially the same, and in which the interleaving of the output pulses includes summing the series of the output pulses of the first and second lasers in a phase-displaced relationship to synthesize a value of the processing pulse repetition frequency that is greater than the pulse repetition frequency of either one of the series of output pulses of the first and second lasers.

6. The method of claim 1, further comprising splitting the combined laser output into third and fourth laser beams that include series of combined laser processing output pulses characterized by peak processing pulse energies; and
directing the third and fourth processing laser beams for incidence on respective third and fourth target material locations to concurrently remove target material from them, the peak processing pulse energies of the combined laser processing output pulses being greater than the peak pulse energies achievable by the first and second lasers operating independently and each being divided into two beams at the processing pulse repetition frequency, thereby enabling selection of a peak processing pulse energy that is effective for target material processing at a processing rate greater than that which is realizable from independent operation of the first and second lasers each being divided into two beams.

7. The method of claim 1, in which the removal of the target material from the first and second target locations forms holes in them.

8. The method of claim 7, in which the holes are in the form of blind vias.
